(19) United States
(12) Patent Application Publication
(10) Pub. No.: US 2024/0242257 A1
(43) Pub. Date: Jul. 18, 2024

(54) SYSTEM AND METHOD FOR EXTRACTING HIERARCHICAL INFORMATION FROM A DATASET CONTAINING ONE-TO-MANY MAPPINGS

(71) Applicant: CONVERTCART SOLUTIONS PRIVATE LIMITED, Bangalore (IN)

(72) Inventors: SANJOTH SHAW, NOIDA (IN); KANIJ FATEMA ALEYA, WEST BENGAL (IN)

(21) Appl. No.: 18/412,059

(22) Filed: Jan. 12, 2024

(30) Foreign Application Priority Data
Jan. 16, 2023 (IN) 202241040809

(51) Int. Cl. G06Q 30/0601

(52) U.S. Cl. CPC G06Q 30/0621

(57) ABSTRACT

The proposed solution provides an efficient mechanism to create a user-friendly hierarchical structure category of products for an e-Commerce or non-e-Commerce website. The method includes the step of mapping of category product, sorting categories, getting immediate superset category, comparing category with a specified threshold value, mapping the immediate superset to immediate subset category, generating subset category, mapping category-category, generating category hierarchy, mapping product-category, generating product hierarchy, and at last getting level-wise categories. This category hierarchical information for each product improves the data quality and performance of features like recommendations, search, and other product discovery solutions and determines the optimum categories to consider while generating product recommendations.

### FIELD OF INVENTION

The present disclosure deals with a system and the process for creating a hidden/latent hierarchical structure to improve the discoverability of products and the user experience. In particular, the present invention discloses an embodiment of the process for creating product-category hierarchical structures of an e-Commerce/non-e-Commerce website. This process not only creates an evenly managed site for a more feasible experience for the user but it also improves the discoverability of the products of the e-commerce or non-e-Commerce website by enhancing performance of features of the website such as search, recommendations, and navigation, so that the user's experiences becomes better.

### BACKGROUND

E-Commerce category pages play a crucial role in guiding users to the right products and navigating through the site. Presently, for all the products listed on the site categorical information is received in the form of a list/array but not in their hierarchical representation i.e., how each category is related to the other.

In general, the hierarchical structure can be represented as a tree structure, tree diagram, or tree model or it can be in a non-graphical or non-tree structure also as long as the information is preserved. Not only in e-Commerce but in a non e-commerce site also, a tree hierarchical structure organizes content like the branches of a tree, seamlessly guiding users from broader categories to specific pages, ensuring effortless navigation. This intuitive layout fosters a clear understanding of information relationships, enhancing user experience.

However, the most popular representation of information is named as a “tree structure” because the classic representation resembles a tree, although the chart is generally upside down compared to a biological tree, with the “stem” at the top and the “leaves” at the bottom.

So based on the flat categorical information, standard analysis of data for various products is possible. However, for a deeper analysis, hierarchical categorical information is needed.

Currently, some e-Commerce platform owners manage this categorization procedure manually. The category levels are defined manually, which is not feasible if the website has many products. Manually managing categories is a time-consuming process and may lead to inconsistency, while configuring the categories.

Even if most of the platform owners follow the manually created category hierarchy system, they may not consider the middle levels of the hierarchy structure and thus provide high weightages to root and bottom level categories. It is highly important to consider the middle levels as it has categories with similar attributes/features and cannot be discarded totally as it plays a vital role for the users looking for similar items with reference to the key item. Providing appropriate weightages to the middle-level, root-level, and bottom-level categories can make systems, such as search and recommendations, work more efficiently and provide optimum results.

E-commerce/non-e-Commerce platforms or Clients can use an algorithm based solely on the frequency of the products that a category contains. Such algorithms are not effective when categories are having an equal number of products. Furthermore, if the number of products is more in some categories but does not belong to a specific level in the hierarchical structure then there are higher chances of getting inadequate results. So as a boon to this process and to improve the data quality and performance of features that use product-category data or any combination thereof, for generating a hierarchical structure of categories of various products is highly recommended.

### OBJECT OF THE INVENTION

The object of the present invention is to provide an efficient mechanism to create a user-friendly hierarchical structure category of products for an e-Commerce or non-e-Commerce website. The proposed solution can be used by any system that uses product-category information or any combination thereof, such as recommendations, search, product selection wizards, etc. It will create different levels of categories and define how each category is linked to one another this in turn will boon the product discovery experience of various users visiting any e-Commerce/non-e-Commerce site.

### SUMMARY OF THE INVENTION

The system and method for extracting hierarchical information as disclosed in the present disclosure offers an efficient and systematic approach to generating a hierarchy for product category or any combination thereof, facilitating effective organization and analysis of products based on their categories. It finds application in various domains where categorization and hierarchical structures are essential, such as e-Commerce platforms, inventory management systems, and data analysis tools.

In an aspect, the recent disclosure provides an efficient mechanism to create a user-friendly hierarchical structure category of products for an e-Commerce/non-e-Commerce website.

According to the present disclosure the system for generating a hierarchy for product categories comprises an input unit, a hierarchy establishing unit. The input unit is adapted to receive a dataset from a user device, wherein the dataset comprises a first mapping related to a unique product identifier, identifying products mapped to category identifiers, identifying product categories or a second mapping, related to unique category identifiers mapped to the unique product identifiers.

A hierarchy establishing unit processes the dataset based on predefined rules to sort the category identifiers in ascending order based on the number of product identifiers mapped to each of the category identifiers.

The sorted category identifiers and their related product identifier mappings are analyzed to discover an immediate superset category identifier for each category identifier. The goal is to ensure that each category identifier has at least one immediate superset category identifier wherein the identifiers comprise a series of numerical digits or alphabetical characters or alphanumeric characters.

According to another embodiment of the system, it discloses how a dummy category identifier has been created at once. If a category identifier does not have an immediate superset category identifier, the hierarchy establishing unit creates a dummy category identifier as an immediate superset category identifier for that category.

According to yet another embodiment of the system, the hierarchy establishing unit may discard category identifiers from the sorted list if they have a product count below a predefined threshold and already have at least one immediate superset category identifier.

According to another embodiment of the system, wherein if two or more category identifiers contain identical product identifiers, then the hierarchy establishing unit is adapted to align such category identifiers at the same hierarchy.

According to one embodiment of the system, the hierarchy establishing unit may discover the plurality of immediate subset category identifiers for each immediate superset category identifier by analyzing the sorted category identifiers and the plurality of their immediate superset category identifiers.

According to another embodiment of the system, the hierarchy establishing unit may generate a complete category hierarchy by using a tree traversal technique to recursively traverse through the plurality of immediate subset category identifiers of each of the immediate superset category identifiers starting from the dummy superset category identifier.

According to yet another embodiment of the system, the hierarchy establishing unit may traverse through the complete category hierarchy to obtain category relationship information. This includes information about the relationship of each product with respect to its category identifiers and the correlation between category identifiers. The category relationship information includes level-wise information, parent-child paths, and child-parent paths among the category identifiers.

According to one embodiment of the invention, the hierarchy establishing unit uses a tree traversal technique such as DFS, BFS, A* to traverse through each of the plurality of category identifiers.

The object of the invention is also achieved by a method for generating a hierarchy for product categories. The method includes steps of:
receiving a dataset by an input unit. The dataset includes a first mapping related to unique product identifiers each identifying one or more products mapped to one or more category identifiers, or a second mapping related to unique category identifiers mapped to one or more product identifiers;
processing the dataset, by the hierarchy establishing unit, based on a predefined set of rules to generate the second mapping if the first mapping is provided in the dataset, and to generate the first mapping if the second mapping is provided in the dataset;
sorting the category identifiers, by the hierarchy establishing unit, in an ascending order based on a number of products mapped to each of the category identifiers; and
analyzing, by the hierarchy establishing unit, the sorted list of category identifiers and the related unique product identifier mappings to discover an immediate superset category identifier for each category identifier, ensuring that each category identifier has at least one immediate superset category identifier.

### BRIEF DESCRIPTION OF DRAWINGS

The novel features and characteristics of the disclosure are set forth in the description. The disclosure itself, however, as well as a preferred mode of use, further objectives, and advantages thereof, will best be understood by reference to the following description of an illustrative embodiment when read in conjunction with the accompanying drawings. One or more embodiments are now described, by way of example only, with reference to the accompanying drawings wherein like reference numerals represent like elements and in which:

FIG. 1 reflects a flowchart of the hierarchical structure comprising of different levels such as top-level or root-level, intermediate level, and bottom-level or leaf-level.

FIG. 2a illustrates system architecture diagrams regarding processing the dataset and generating the appropriate mapping in accordance with an embodiment of the present invention.

FIG. 2b illustrates system architecture diagrams regarding creating a dummy category identifier, discarding certain category identifiers, discovering the immediate subset category identifiers, generating the complete category hierarchy in accordance with an embodiment of the present invention.

FIG. 2c illustrates system architecture diagrams regarding traversing through the complete category hierarchy in accordance with an embodiment of the present invention.

FIG. 3 reflects a flowchart of a step-wise process for hierarchical structure creation of categories at a product-level and at website/store level.

FIG. 4a—shows an example of a category hierarchical structure of one of the products, with different levels as mentioned in FIG. 1.

FIG. 4b—shows an example of a category hierarchy of the entire e-commerce or non-e-Commerce website/sore wherein this structure is not specific to just one product.

The figures depict embodiments of the disclosure for purposes of illustration only. One skilled in the art will readily recognize from the following description that alternative embodiments of the assemblies, structures, and methods illustrated herein may be employed without departing from the principles of the disclosure described herein.

### DETAILED DESCRIPTION OF DRAWINGS

For the purpose of promoting an understanding of the principles of the invention, reference will now be made to the embodiment illustrated in the Figs, and specific language will be used to describe them. It will nevertheless be understood that no limitation of the scope of the invention is thereby intended. Such alterations and further modifications in the illustrated system, and such further applications of the principles of the invention as would usually occur to those skilled in the art are to be construed as being within the scope of the present invention.

It will be understood by those skilled in the art that the foregoing general description and the following detailed description are exemplary and explanatory of the invention and are not intended to be restrictive thereof.

The terms “comprise”, “comprising”, or any other variations thereof, are intended to cover a non-exclusive inclusion, such that a process or method that comprises a list of steps does not include only those steps but may include other steps not expressly listed or inherent to such a process or method. Similarly, one or more sub-systems or elements or structures or components preceded by “comprises . . . a” does not, without more constraints, preclude the existence of other, sub-systems, elements, structures, components, additional sub-systems, additional elements, additional structures, or additional components. Appearances of the phrase “in an embodiment”, “in another embodiment”, and similar language throughout this specification may, but not necessarily do, all refer to the same embodiment.

Unless otherwise defined, all technical and scientific terms used herein have the same meaning as commonly understood by those skilled in the art to which this invention belongs. The system, methods, and examples provided herein are only illustrative and not intended to be limiting. Embodiments of the present invention will be described below in detail with reference to the accompanying Figs.

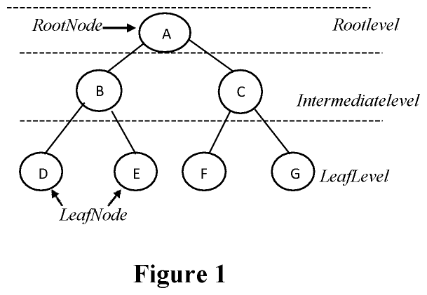

The objective of the proposed categorization process is the unique feature of the creation of the product-wise category hierarchy structure for an e-Commerce store. According to the present disclosure the unique features are as mentioned below: FIG. 1 illustrates a general hierarchical structure which is common for both product-wise category hierarchies and the main category hierarchy. In the hierarchical structure as shown in FIG. 1 it also depicts a top-level or root level, intermediate levels, bottom—most level, or leaf level—for all products of an e-Commerce or non-e-commerce Store/website which helps to improve the data quality and data visibility to the user.

Creating hierarchical data from linear data can improve the effectiveness of the system disclosed herein as it creates different levels of categories and define how each category is linked to one another this in turn will boon the product discovery experience of various users visiting any e-Commerce site. In fact the hierarchical structure as disclosed in the present disclosure can be used in any of the website where hierarchical relationships exist amongst two or more entities. In one of the implementation of the present disclosure it can be used for any two entities that have a hidden/latent hierarchical structure.

The present disclosure discloses a system and method for generating a hierarchy for product categories. It includes an input unit to receive a dataset containing mappings of unique product identifiers to category identifiers or vice versa. A hierarchy establishing unit processes the dataset based on predefined rules; sorts the category identifiers in ascending order based on product counts; and analyzes them to discover immediate superset category identifiers for each category. A dummy category identifier is created for categories without an immediate superset. The hierarchy establishing unit generates a complete category using a tree traversal technique, providing category relationship information and correlation details between category identifiers.

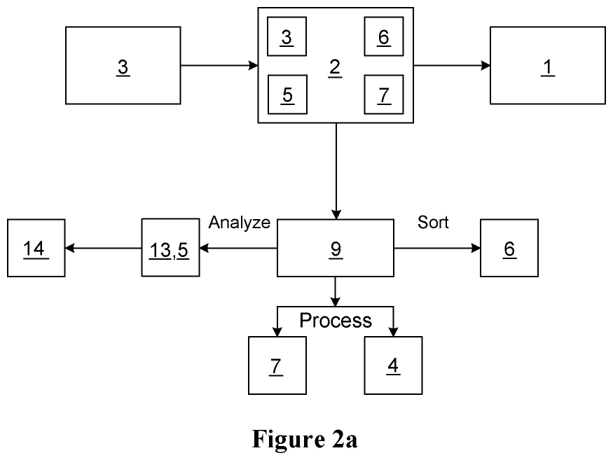

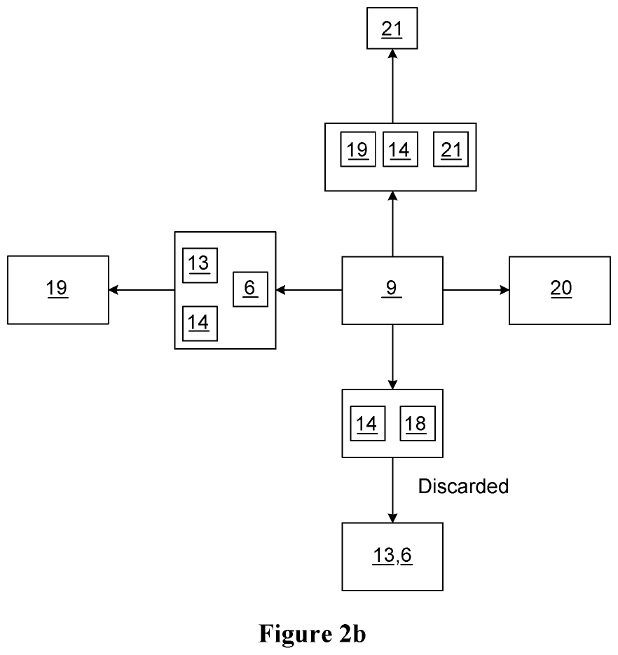

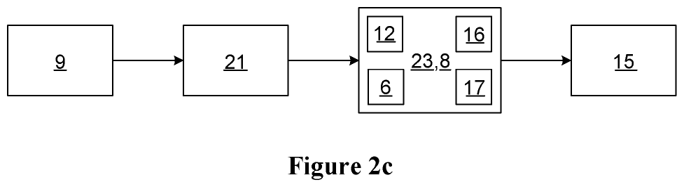

As illustrated in FIG. 2a, a system (100) designed to generate a hierarchy for product categories. The system (100) for generating a hierarchy for product categories comprises an input unit (1) and a hierarchy establishing unit (9).

According to the present disclosure, product identifiers (5) are unique in nature. The product identifiers (5) are assigned to individual products within the dataset (2). They serve as unique references to identify specific products.

The input unit (1) receives a dataset (2) from a user device (3). The dataset (2) contains either a first mapping (4) associating unique product identifiers (5) with one or more category identifiers (6), or a second mapping (7) linking unique category identifiers (6) to one or more product identifiers (5).

In the present disclosure the category identifiers (6) are used to classify and group products within the dataset (2). Each category identifier (6) corresponds to one or more product identifiers (5).

To establish the hierarchy, a hierarchy establishing unit (9) processes the dataset (2) based on a predefined set of rules (11). If the first mapping (4) is provided, the system may generate the second mapping (7), and if the second mapping (7) is provided, it generates the first mapping (4).

In the event that the data is exclusively presented in the first mapping format characterized by a product-to-category relationship, the system shall process the data in its existing format. Conversely, should data be provided in the second mapping format, delineating a category-to-product relationship, the system is configured to transform this data into the first mapping format. Furthermore, in instances where data is supplied in both aforementioned formats, the system will convert and standardize it into the first mapping format.

### Example

In a retail inventory system, products like “Smartphone” or “Running Shoes” might be categorized under “Electronics” or “Sportswear” respectively (first format: product-to-category). If the system receives data with categories leading to products, for example, “Electronics” leading to “Smartphone”, it will rearrange this to fit the product-to-category format. In practical scenarios, this feature is useful for data consistency. For instance, a store receives mixed data from various suppliers: one lists “Laptops” under “Computers”, while another starts with “Computers” and lists “Laptops”. The system will uniformly convert all these inputs into a product-to-category format, such as “Laptop—Computers”, ensuring consistency in the inventory database.

The second mapping (7) in the dataset (2) establishes the relationship between category identifiers (6) and one or more product identifiers (5). This mapping defines the products associated with each category.

In operation according to the present disclosure, first the category-category relationship is generated and only then one can get the product-category relationship but not vice-versa.

The category identifiers (6) are sorted in ascending order based on the number of products mapped to each category. Through analysis of the sorted list (13) and the related product identifier (5) are mapped.

The sorted list (13) comprises the category identifiers (6) arranged in ascending order based on the number of products mapped to each category identifier (6). This sorting enables a systematic analysis of the categories.

The system analyzes the sorted list (13) of category identifiers (6) and the related unique product identifier (5) mappings to identify an immediate superset category identifier (14) for each category identifier (6). This analysis ensures that each category identifier (6) has at least one immediate superset category identifier (14). Each category identifier (6) is assigned at least one immediate superset category identifier (14) based on the analysis performed by the system.

According to an embodiment of the present disclosure the identifiers (5,6) as mentioned herein above may comprises a series of numerical digits or alphabetical characters or alphanumeric characters.

In one of the embodiments of the present disclosure some categories may have zero (null) immediate superset category identifiers (14) then a dummy superset (20) (as a parent) for those category identifiers (6) has been added, at once, that didn't contain any immediate superset category identifiers (14).

As illustrated in FIG. 2(b) the hierarchy establishing unit (9) creates a dummy category identifier (20) as an immediate superset category identifier (14) for categories that do not have one category identifier (6). Moreover, the hierarchy establishing unit (9) is adapted to discard category identifiers (6) from the sorted list (13) that have a product count below a predefined threshold (18) and already have at least one immediate superset category identifier (14).

In one of the embodiments the hierarchy establishing unit (9) analyzes the sorted list (13) of category identifiers (6) and their immediate superset category identifiers (14) to discover a plurality of immediate subset category identifiers (19) for each immediate superset category identifier (14). This feature of the present disclosure gives rise to the technical effect wherein the system can handle complex category hierarchies and improve its overall performance.

In another embodiment the hierarchy establishing unit (9) may generate a complete category hierarchy (21) by using a tree traversal technique (20) to recursively traverse through the plurality of immediate subset category identifiers (19) for each immediate superset category identifier (14), starting from the dummy superset category identifier (21).

In the realm of e-Commerce, effectively establishing accurate category-product or any combination thereof relationships is crucial for enhancing user experience, search functionalities, and personalized recommendations.

As illustrated in FIG. 2c in one of the embodiments the hierarchy establishing unit (9) may utilizes an efficient traversal mechanism to navigate through the complete category hierarchy (21). In one of the implementation the hierarchy establishing unit (9) uses depth first search (DFS) tree traversal technique to traverse through each of the plurality of category identifiers (6).

Additionally, the DFS strategy allows the system to gather comprehensive information about each product's relationship with its associated category identifiers (6). By analyzing the hierarchical structure, the system gains a deeper understanding of the relationships between products and categories, enabling enhanced categorization and classification processes.

To be precise, according to the present disclosure in operation, one might get the information about relationship between
one category identifier to other category identifiers
one product identifier to each of it's category identifiers.

However, in the present disclosure one can only get the product-category relationship after category-category relationship (category hierarchy) is already created.

According to the present disclosure by doing this depth first search, the system obtains vital information regarding the relationship between each product and its corresponding category identifiers (6). Moreover, it also collects category-category relationship information (8) that signifies the correlation between different category identifiers (6). This category relationship information (8) includes level-wise information (12), parent-child paths (16), and child-parent paths (17) among the category identifiers (6).

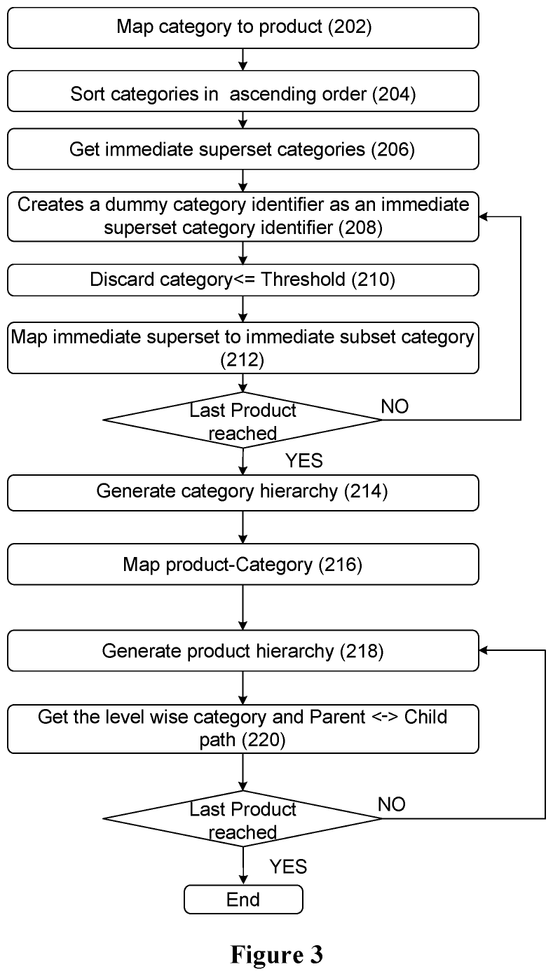

According to the present disclosure the proposed method shown in FIG. 3 can also be used for creating hierarchical structures based on other mappings, such as attribute-product, tags-webpage, or any other mappings that share a mapping structure similar to that of category-product or product-category mapping.

Hierarchically categorizing the products allows the product discovery activity to work more effectively and fetch relevant products. As a result, it helps the client create the most optimized product discovery solutions. Since the product discovery activity is often the first action users perform on e-Commerce sites, a strong product discovery tool is pinnacle to the user experience of the site.

Steps, as given in FIG. 3, are explained below for the creation of a hierarchical structure for an e-Commerce/non-e-Commerce site wherein the hierarchical relationships exist amongst two or more entities.

In the first step (202) of FIG. 3, each product has an identity, a series of numerical or alphanumerical digits used to identify a specific product. Each product belongs to one or many categories. In this step, the algorithm scrutinizes every product based on its identity and maps them to their respective categories (Table 1).

TABLE 1

| Category Name | Product Ids |
|---|---|
| Appliances | [1007, 1008, 1009, 1010, 10055, 10056, 10057] |
| Electronics | [1055, 1056, 1057, 1058, 1015, 1007, 1008, |
| | 1009, 1010] |

According to an embodiment of the present disclosure the method begins with the input unit receiving a dataset. This dataset contains mappings, either in the form of a first mapping associating unique product identifiers with one or more category identifiers or a second mapping associating unique category identifiers with one or more product identifiers.

In another embodiment of the present disclosure the hierarchy establishing unit processes the dataset, employing a predefined set of rules to generate the missing mapping. If the dataset includes the first mapping, the unit generates the second mapping, and vice versa. This step ensures that the dataset contains both mappings for further analysis.

In the second step (204) of FIG. 3, the categories are sorted (204) in an ascending order based on the product counts. This is one of the core steps in this algorithm which is essential to get the nodes in the hierarchical form and also plays a vital role in getting the immediate supersets.

In the third step (206) of FIG. 3, the algorithm scrutinizes and gets immediate superset categories for each category and also handles categories without immediate supersets.

In another embodiment for handling categories without immediate supersets is to create a dummy category (208) at once and then use that dummy category as a superset for all such categories to make the tree traversal easier.

In operation according to the present disclosure some categories may have zero (null) immediate superset category identifiers (14) then a dummy superset (20) (as a parent) for those category identifiers (6) has been added that didn't contain any immediate superset category identifiers (14). In the fourth step (210) of FIG. 3, discarding the categories whose product count is less than the specified threshold value and has at least one superset. To consider the categories in the hierarchical structure a specific threshold value should be defined based on the requirement which is essential to discard the categories having a smaller number of products and will not play a vital role in the product discovery solution.

In the fifth step (212) of FIG. 3, the algorithm shall traverse through each immediate category to achieve immediate superset and subset category mapping. (Table 2)

TABLE 2

| Immediate superset | Immediate Subsets |
|---|---|
| Appliances | [Home, AC, Office, Microwave] |
| Home | [AC for Home] |
| All products | [Electronics, Computer] |

In one of the embodiments the hierarchy establishing unit is adapted to generate the complete category hierarchy by using a tree traversal technique to recursively traverse through the plurality of immediate subset category identifiers of each of the immediate superset category identifiers starting from the dummy category identifier as shown in FIG. 3.

In the above table, the superset is the ‘Appliances’ category i.e., parent node, and subsets are Home, AC, Office, Microwave i.e., child nodes. Similarly, ‘All Products’ is the root node, the highest node in the tree structure, with no parent. Traversing through the different category nodes can be performed using any traversing technique. In this algorithm, the Depth First Search traversal technique has been used to get the tree structure category hierarchy. Depth-first search is an algorithm for traversing or searching tree or graph data structures. The algorithm starts at the root node (selecting some arbitrary node as the root node in the case of a graph) and explores as far as possible along each branch before backtracking.

In the sixth step (214) of FIG. 3, After traversing and visiting each immediate superset and immediate subset category starting from the root category using the tree traversing technique a relationship is obtained between different nodes using which a category hierarchy is created.

Once the category hierarchy is generated according to the present disclosure it shall traverse through the category hierarchy using the tree traversal technique to get the level-wise categories and parent-child and child-parent path as shown in FIG. 3 as in step (216).

In this eight step (218) of FIG. 3, each product ID is mapped to its respective categories. A product that is mutual to certain categories is mapped accordingly. This step is performed to identify mutual products belonging to multiple categories.

TABLE 3

| Product Id | Categories |
|---|---|
| 1058 | [′Electronics′, ′Appliances′, ′AC′] |
| 1015 | [′Electronics′, ′Appliances′] |
| 1007 | [′Electronics′, ′Appliances′, ′Home′, ′Kitchen |
| | Appliances′] |

In the ninth step (220) of FIG. 3, With reference to category hierarchy, a product hierarchy is created. It shall traverse through the entire category hierarchy using any tree traversing technique only for the categories that belong to that specific product and follow the same procedure for each product to get that product's category hierarchy.

In the last step (222) of FIG. 3, It shall traverse through the product's category hierarchy using the tree traversal technique to get the level-wise categories and parent-child and child-parent path as shown in FIG. 3. The algorithm will run a loop until each product's category is created.

In one of the implementations of the present disclosure can be used to generate category hierarchy or product hierarchy wherein in both the cases it will not generate any level wise category or parent child path. However, in another implementation, as disclosed in the present disclosure may be used to generate category hierarchy or product hierarchy wherein in both the cases it can generate level wise category or parent child path which as a technical effect improve the discoverability of products and the user experience.

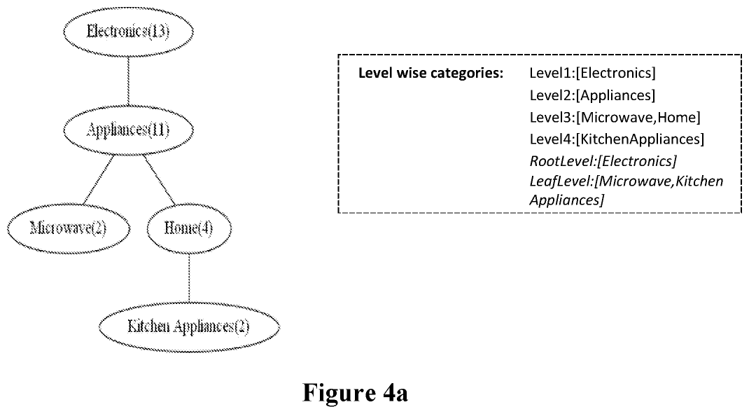

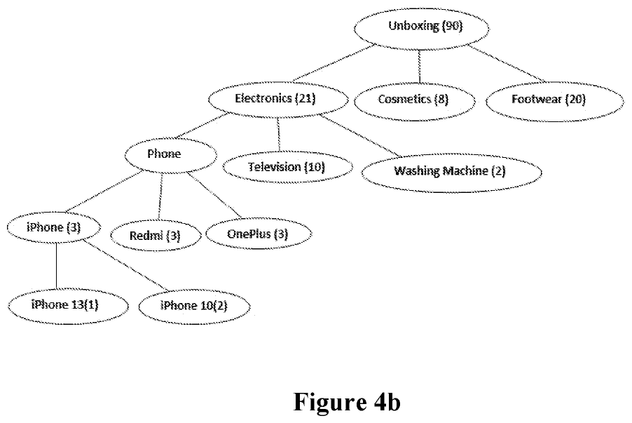

Further, FIG. 4a shows an example of a category hierarchy of one of the products and FIG. 4b shows a category hierarchy of the entire e-commerce/non-e-Commerce Website's or store but not specified to just one product. The FIG. 4(a) further shows the level-wise categories of a particular product, where the Root level is ELECTRONICS and the Leaf level is MICROWAVE, KITCHEN, and APPLIANCES.

### Advantages

The algorithm can be used by any feature that uses product-category information such as recommendations, search, product selection wizards, etc. The algorithm can also be used for creating hierarchical structures based on other one-to-many mappings, such as attribute-products, 10 webpage-tags, videos-tags, or any other mappings that share a mapping structure similar to that of category-product. The advantages of using an algorithm are:
To help determine the optimum categories to consider while generating product recommendations and search results
To suggest relevant category filters while generating search results
To remove unnecessary categories from the category hierarchy structure based on a specified threshold value.
To help clients improve their Product Cataloging by seeing how their categories are linked with each other and export the structure in an image format that is easier for anyone to view.
Using category hierarchical information for each product to improve the data quality and performance of features like recommendations, search, and other product discovery solutions.
To create a hierarchical structure of any entity bearing child-parent relationships.

### Example

Let us consider the relationship between the tags and the videos on YouTube (digital channel). YouTube tags/keywords function helps it to locate and display the relative video's content and context. Tags are descriptive keywords that help viewers find the required videos on YouTube. According to YouTube, the tags (along with the video's title, thumbnail, and description) are the important piece of metadata you need to provide to find the most accurate result. This way, YouTube can understand the video's topic and category, and associate it with similar content. If a user is searching for a video having the tags “Unboxing of iPhone 13” then based on the tags and the videos uploaded on the site the system can traverse through the generated hierarchy structure and the most relevant video will be listed on the top which in turn can make the search discovery process more efficient.

As per FIG. 4(a)-(b), altogether 90 unboxing videos are uploaded on YouTube, and the relevant video is present at the leaf level having an “iPhone 13” tag.

The embodiments herein and the various features and advantageous details thereof are explained with reference to the non-limiting embodiments in the description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein. Any discussion of documents, acts, materials, devices, articles and the like that has been included in this specification is solely for the purpose of providing a context for the disclosure.

It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the particular features of this disclosure, it will be appreciated that various modifications can be made, and that many changes can be made in the preferred embodiments without departing from the principles of the disclosure. These and other modifications in the nature of the disclosure or the preferred embodiments will be apparent to those skilled in the art from the disclosure herein, whereby it is to be distinctly understood that the foregoing descriptive matter is to be interpreted merely as illustrative of the disclosure and not as a limitation.

### LIST OF REFERENCE NUMERALS

system (100)
input unit (1)
dataset (2)
user device (3)
first mapping (4)
product identifiers (5)
category identifiers (6)
second mapping (7)
category-category relationship information (8)
hierarchy establishing unit (9)
child-parent path (10)
predefined set of rules (11)
level-wise information (12)
sorted list (13)
superset category identifier (14)
category-product relationship information (15)
parent-child path (16)
child-parent path (17)
predefined threshold (18)
subset category identifiers (19)
dummy category identifier (20)
complete category hierarchy (21)

I/We claim:

1. A system (100) for generating a hierarchy for product categories, the system (100) comprising:
an input unit (1) adapted to receive a dataset (2) from a user device (3), wherein the dataset (2) comprises a first mapping (4) related to unique product identifiers (5) each identifying one or more products mapped to one or more category identifiers (6) or a second mapping (7) related to unique category identifiers (6) mapped to one or more product identifiers (5);
a hierarchy establishing unit (9) configured to:
process the dataset (2) based on a predefined set of rules (11) to
sort the category identifiers (6) in an ascending order based on a number of products identifiers (5) mapped to each of the category identifiers (6);
analyse the sorted list (13) of category identifiers (6) and the related unique product identifier (5) mappings to discover an immediate superset category identifier (14) for each category identifier (6) such that each category identifier (6) shall be having at least one immediate superset category identifier (14); and
generate the hierarchy of product categories.

2. The system (100) as claimed in claim 1, wherein in the hierarchy establishing unit (9) is adapted to create a dummy category identifier (20), initialized at once, as an immediate superset category identifier (14) for each of the category identifiers (6) that do not have an immediate superset category identifier (14).

3. The system (100) as claimed in claim 2, wherein the hierarchy establishing unit (9) is adapted to discard from the plurality of sorted category identifiers (6) from the sorted list (13) that have product count less than a predefined threshold (18) and that have at least one immediate superset category identifier (14).

4. The system (100) as claimed in claim 1, wherein if two or more category identifiers contain identical product identifiers, then the hierarchy establishing unit (9) is adapted to align such category identifiers at the same hierarchy.

5. The system (100) as claimed in claim 1, wherein the hierarchy establishing unit (9) is adapted to discover the plurality of immediate subset category identifiers (19) for each immediate superset category identifier (14) by analysing the sorted list (13) of the category identifiers (6) and the plurality of their immediate superset category identifiers (14).

6. The system (100) as claimed in claim 5, wherein the hierarchy establishing unit (9) is adapted to generate a complete category hierarchy (21) by using a tree traversal technique to recursively traverse through the plurality of immediate subset category identifiers (19) of each of the immediate superset category identifiers (14) starting from the dummy category identifier (21).

7. The system (100) as claimed in claim 6, wherein the hierarchy establishing unit (9) is adapted to traverse through the complete category hierarchy (21) to obtain a category-product relationship information (15) for each product with respect to each of its category identifiers (6), and category-category relationship information (8) related to correlation of each category identifiers (6) with respect to each other, wherein the category relationship information (8) comprises level-wise information (12), parent-child path (16), and child-parent path (17) amongst the category identifiers (6).

8. The system (100) as claimed in claim 6, wherein the hierarchy establishing unit (9) uses depth first search (DFS), BFS, A* or any other tree traversal technique to traverse through each of the plurality of category identifiers (6).

9. The system (100) as claimed in claim 1, wherein the identifiers (5,6) comprises a series of numerical digits or alphabetical characters or alphanumeric characters.

10. A method (200) for generating a hierarchy for product categories, the method (200) comprises: receiving (201) a dataset (2), by an input unit (1), wherein the dataset (2) comprises a first mapping (4) related to unique product identifiers (5) each identifying one or more products mapped to one or more category identifiers (6), or a second mapping (7) related to unique category identifiers (6) mapped to one or more product identifiers (5);
processing (202) the dataset (2), by the hierarchy establishing unit (9), based on a predefined set of rules to generate the second mapping (7) if the first mapping (4) is provided in the dataset (2), and to generate the first mapping (4) if the second mapping (7) is provided in the dataset (2);
sorting (204) the category identifiers (6), by the hierarchy establishing unit (9), in an ascending order based on a number of products mapped to each of the category identifiers (6); and
analyzing (206), by the hierarchy establishing unit (9), the sorted list of category identifiers (13) and the related unique product identifier (5) mappings to discover an immediate superset category identifier (14) for each category identifier (6), ensuring that each category identifier (6) has at least one immediate superset category identifier (14).

11. The method (208) as claimed in claim 10, wherein the hierarchy establishing unit (9) is adapted to create a dummy category identifier (20), initialized at once, as an immediate superset category identifier (14) for each of the category identifiers (6) that do not have an immediate superset category identifier (14).

12. The method (210) as claimed in claim 11, wherein the hierarchy establishing unit (9) is adapted to discard from the plurality of sorted category identifiers (6) from the sorted list (13) that have product count less than a predefined threshold (18) and that have at least one immediate superset category identifier (14).

13. The method (212) as claimed in claim 10, wherein the hierarchy establishing unit (9) is adapted to discover the plurality of immediate subset category identifiers (19) for each immediate superset category identifier (14) by analysing the sorted list (13) of the category identifiers (6) and the plurality of their immediate superset category identifiers (14).

14. The method (214, 216) as claimed in claim 13, wherein the hierarchy establishing unit (9) is adapted to generate a complete category hierarchy (21) by using a tree traversal technique to recursively traverse through the plurality of immediate subset category identifiers (19) of each of the immediate superset category identifiers (14) starting from the dummy category identifier (21).

15. The method (218, 220) as claimed in claim 14, wherein the hierarchy establishing unit (9) is adapted to traverse through the complete category hierarchy (21) to obtain a category-product relationship information (15) for each product with respect to each of its category identifiers (6), and category-category relationship information (8) related to correlation of each category identifiers (6) with respect to each other, wherein the category relationship information (8) comprises level-wise information (12), parent-child path (16), and child-parent path (17) amongst the category identifiers (6).
